(19) United States
(12) Patent Application Publication
(10) Pub. No.: US 2011/0157103 A1
(43) Pub. Date: Jun. 30, 2011

(54) Display Device and Driving Circuit

(75) Inventors: Pen-Hsin Chen, Sinshih Township (TW); Ying-Lieh Chen, Sinshih Township (TW)

(73) Assignee: HIMAX TECHNOLOGIES LIMITED, Sinshih Township (TW)

(21) Appl. No.: 12/648,016

(22) Filed: Dec. 28, 2009

(51) Int. Cl. G06F 3/038

(52) U.S. Cl. 345/204

(57) ABSTRACT

A display device is provided, including a panel, source driver chips, a gate driver chip, a printed circuit board and transmission lines. The panel includes light emitting elements and display cells. The display cells are respectively connected to data lines and gate lines. The source driver chips output pixel signals to the data lines. At least one source driver chip includes a timing controller integrated therein for generating timing control signals and the pixel signals according to an image control signal provided by a host. The gate driver chip outputs corresponding scan signals to the gate lines. The transmission lines are routed on the printed circuit board and connect to the source driver chips.

### BACKGROUND OF THE INVENTION

1. Field of the Invention

The invention relates to a display device, and more particularly, to a display device with an integrated timing controller and source driver.

2. Description of the Related Art

Liquid Crystal Displays (LCDs) have become popular due to characteristics thereof such as fast response time, light weight, slim profile, high luminance, low power consumption and highly enlargeable display area . . . etc. To increase LCD panel resolution and achieve high definition LCDs, source drivers thereof and transmission speed between timing controllers and source drivers thereof are required to be increased.

Conventionally, a timing controller of an LCD is configured on a printed circuit board (PCB) and connected between the source drivers and a host providing image data. The timing controller receives timing signals and the image data from the host and converts the timing signals and the image data to transmit to the source drivers. However, transmission performance degrades as size of the LCD increases due to increased transmission error rate because of longer transmission lines therein. Additionally, as size of the LCD increases, size of PCBs of the timing controllers also increase, thus increasing costs. Thus, novel data driving circuit structures for reducing costs and improving the transmission performance of a high definition LCD are highly required.

### BRIEF SUMMARY OF THE INVENTION

Display devices and driving circuits for outputting pixel signals to control a liquid crystal display panel are provided. An embodiment of a display device includes a panel, source driver chips, a gate driver chip, a printed circuit board and transmission lines. The panel includes light emitting elements and display cells. The display cells are respectively connected to data lines and gate lines. The source driver chips output pixel signals to the data lines. At least one source driver chip includes a timing controller integrated therein for generating timing control signals and the pixel signals according to an image control signal provided by a host. The gate driver chip outputs corresponding scan signals to the gate lines. The transmission lines are routed on the printed circuit board and connect to the source driver chips.

An embodiment of a driving circuit for outputting pixel signals to control a liquid crystal display panel having light emitting elements and display cells respectively connecting to data lines and gate lines is provided, including source driver chips, a printed circuit board and transmission lines. The source driver chips output the pixel signals to the data lines. One source driver chip comprises a timing controller integrated therein for generating a plurality of timing control signals and the pixel signals according to an image control signal provided by a host. The transmission lines are routed on the printed circuit board and connect to the source driver chips.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic block diagram of a display device 100 according to an embodiment of the invention;

FIG. 2 shows a schematic block diagram of a source driver chip with a timing controller integrated therein according to an embodiment of the invention;

FIG. 3 shows a schematic layout of a driving circuit according to a first embodiment of the invention;

FIG. 4 shows a schematic layout of a driving circuit according to a second embodiment of the invention;

FIG. 5 shows a schematic layout of a driving circuit according to a third embodiment of the invention; and

FIG. 6 shows a schematic layout of a driving circuit according to a fourth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

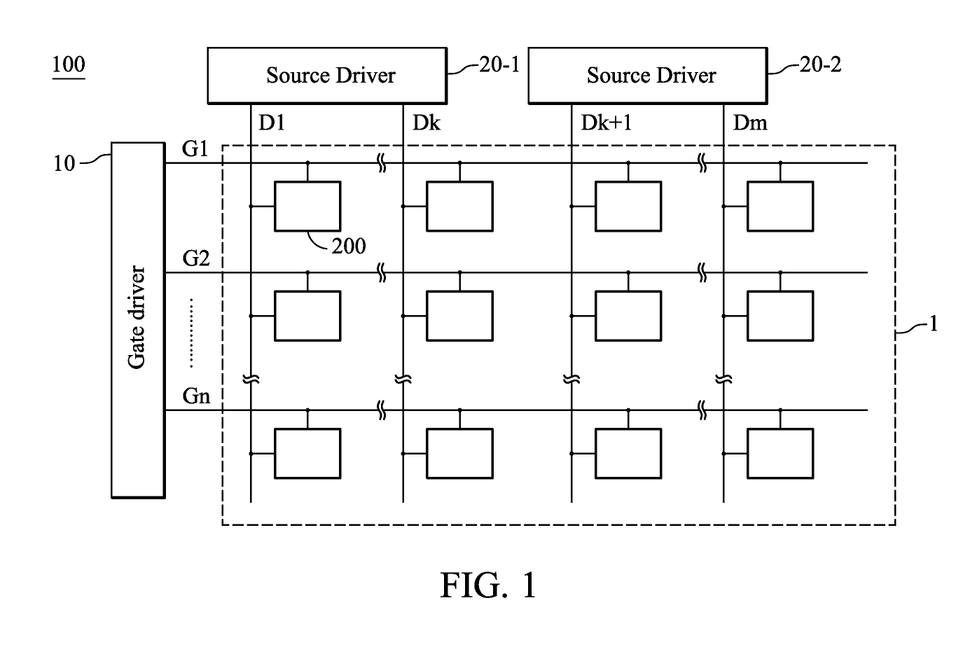

FIG. 1 is a schematic block diagram of a display device 100 according to an embodiment of the invention. As shown in the figure, an LCD panel 1 is formed by interlacing data lines (represented by D1, D2, . . . , Dm) and gate lines (represented by G1, G2, . . . , Gm), each pair of which controls a display cell. As an example, interlacing data line D1 and gate line G1 control the display cell 200. The gate driver chip 10 is coupled to the panel 1 and outputs corresponding scan signals to the gate lines G1, G2, . . . , Gm. The source driver chips 20-1 and 20-2 output a plurality of pixel signals to the data lines D1, D2, . . . , Dm. According to an embodiment of the invention, at least one source driver chip comprises a timing controller integrated therein for generating a plurality of timing control signals and the pixel signals according to an image control signal provided by a host (not shown). The host may be a computer, a display card, or the likes.

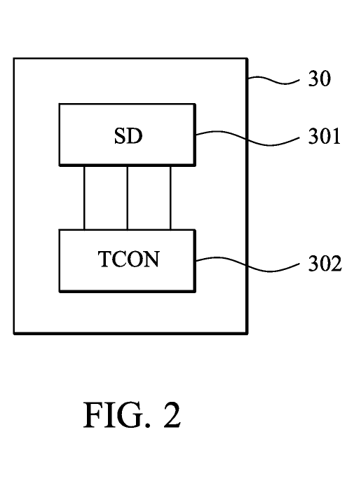

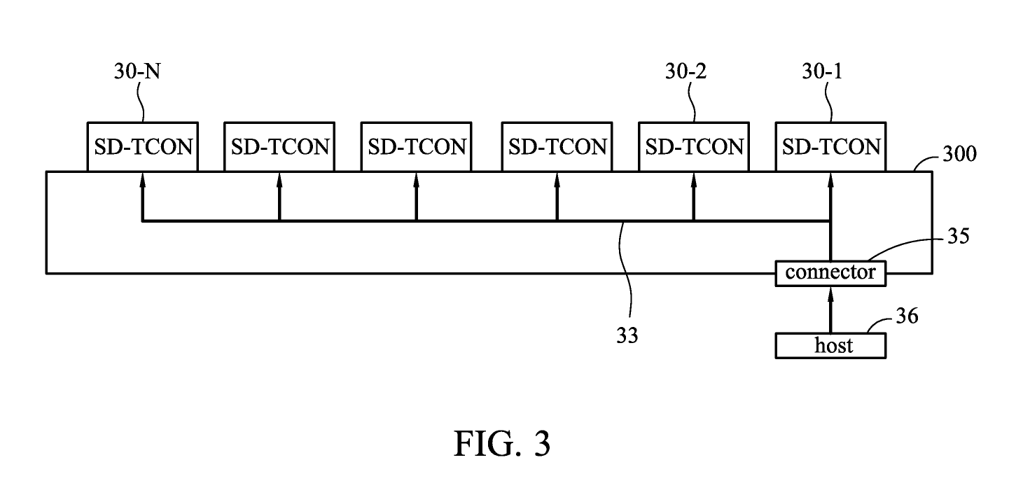

FIG. 2 shows a schematic block diagram of a source driver chip 30 which integrated a source driver (SD) 301 and a timing controller (TCON) 302 according to an embodiment of the invention. According to an embodiment of the invention, since the source driver 301 and the timing controller 302 are integrated together, the transmitter and receiver built in the source driver and the timing controller as with the conventional design are no longer needed. In this manner, the cost for the source driver and the timing controller is reduced. FIG. 3 shows a schematic layout of a driving circuit utilizing plural of the source driver chips 30 shown in FIG. 2 according to a first embodiment of the invention. It should be noted that for simplicity, only the components related to the proposed layout structure will be shown and discussed. For persons with ordinary skill in the art, it is easy to derive the non-discussed elements and circuits of FIG. 3, and the invention is not limited thereto.

As shown in FIG. 3, the driving circuit comprises a printed circuit board 300, a plurality of source driver chips 30-1, 30-2, . . . , 30-N, a plurality of transmission lines 33 routed on the printed circuit board and connected to the source driver chips, and a connector 35 located on the printed circuit board 300 and coupled to the host 36 and at least one source driver chip. According to the first embodiment of the invention, each source driver chip comprises one timing controller integrated therein and thus, is represented by SD-TCON. As shown in the figure, each source driver chip is coupled to the connector 36 via the transmission lines 33. For the structure of the source driver chips 30-1, 30-2, . . . , 30-N with a timing controller integrated therein, reference may be made to FIG. 2 and the corresponding paragraphs, and repeated descriptions are omitted here for brevity. According to an embodiment of the invention, the source driver chips 30-1, 30-2, . . . , 30-N receive the image control signal provided by the host 36 from the connector 35, generate the timing control signals and the pixel signals according to the host, and output corresponding pixel data to the data lines D1, D2, . . . , Dm as shown in FIG. 1. The timing control signals may comprise a start pulse signal (as an example, an EIO signal) for each source driver chip to indicate the time the source driver chip to latch pixel data. The timing control signals may further comprise a pixel clock signal to indicate a pixel data transmission frequency of the pixel signals. On the other hand, there may be only one timing controller in one source driver chip 30-1, for example, enabled, and the other timing controllers in other source driver chips 30-2, . . . , 30-N may also be disabled. In this manner, the timing control signals and the pixel signals required by the source driver chips 30-2, . . . , 30-N may all be received from the source driver chip 30-1. In one aspect of the embodiment of the invention, the transmission lines 33 may be a differential bus, such as a low-voltage differential signaling (LVDS) bus, or the likes. The source driver chips 30-1, 30-2, . . . , 30-N may be packaged on the PCB 300 by the Chip On Film (COF) or the Chip On Glass (COG) package technologies. As can be seen, since the timing controller is integrated in the source driver, the PCB area required by the timing controller in the conventional design may be decreased.

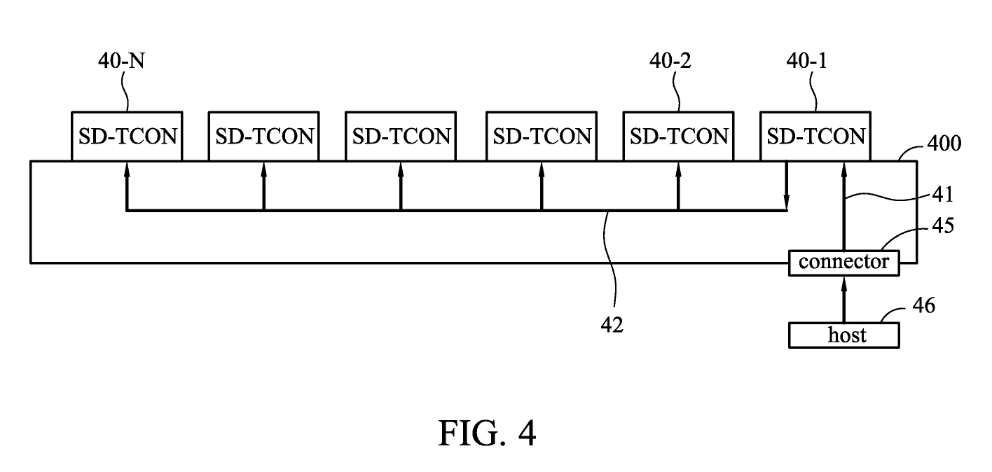

FIG. 4 shows a schematic layout of a driving circuit according to a second embodiment of the invention. It should be noted that for simplicity, only the components related to the proposed layout structure will be shown and discussed. For persons with ordinary skill in the art, it is easy to derive the non-discussed elements and circuits of FIG. 4, and the invention is not limited thereto. As shown in FIG. 4, the driving circuit comprises a printed circuit board 400, a plurality of source driver chips 40-1, 40-2, . . . , 40-N, a plurality of transmission lines 41 and 42 routed on the printed circuit board 400 and connected to the source driver chips, and a connector 45 located on the printed circuit board 400 and coupled to the host 46 and at least one source driver chip. According to the second embodiment of the invention, each source driver chip comprises one timing controller integrated therein and thus, is represented by SD-TCON. Only one source driver chip 40-1 is coupled to the connector 45 via the transmission line 41, and the source driver chips 40-1, 40-2, . . . , 40-N are coupled to each other via the transmission line 42.

According to an embodiment of the invention, the timing controller of the source driver chip 40-1 receives the image control signal provided by the host 46 from the connector 45, generates the timing control signals and the pixel signals according to the image control signal, and the source driver chip 40-1 transmits the timing control signals and the pixel signals to the source driver chips 40-2, . . . , 40-N that are not coupled to the connector. According to an embodiment of the invention, the timing control signals may comprise a start pulse signal (as an example, an EIO signal) for each source driver chip to indicate the time for the source driver chip to latch pixel data, a pixel clock signal to indicate a pixel data transmission frequency of the pixel signals, and a data enable signal indicating whether the pixel data of the pixel signals is active data or blanking data. The source driver chips 40-1, 40-2, . . . , 40-N then output corresponding pixel data to the data lines D1, D2, . . . , Dm as shown in FIG. 1 according to the timing control signals and the pixel signals. Since each source driver chips 40-1, 40-2, . . . , 40-N comprise one timing controller integrated therein, the timing controllers, respectively generate the remaining required timing control signals. Thus, the amount of data transmission on the transmission lines 42 are reduced.

In one aspect of the embodiment of the invention, a transmission speed of the transmission line 41 may be faster than that of the transmission line 42. As an example, the transmission line 41 may be an LVDS bus, and the transmission line 42 may be a reduced swing differential signaling (RSDS) bus. The transmission line 42 may also be any other transmission interface with fewer data lines as compared to the conventional transmission lines. On the other hand, the timing controller integrated in the source driver chips 40-2, . . . , 40-N that are not coupled to the connector 45 may also be disabled. In this manner, the timing control signals and the pixel signals required by the source driver chips 40-2, . . . , 40-N may all be received from the source driver chip 40-1. According to the embodiment of the invention, the source driver chips 40-1, 40-2, . . . , 40-N may be packaged on the PCB 400 by the Chip On Film (COF) or the Chip On Glass (COG) package technologies. As can be seen, since the timing controller(s) is integrated in the source drivers, the PCB area required by the timing controller in the conventional design is decreased.

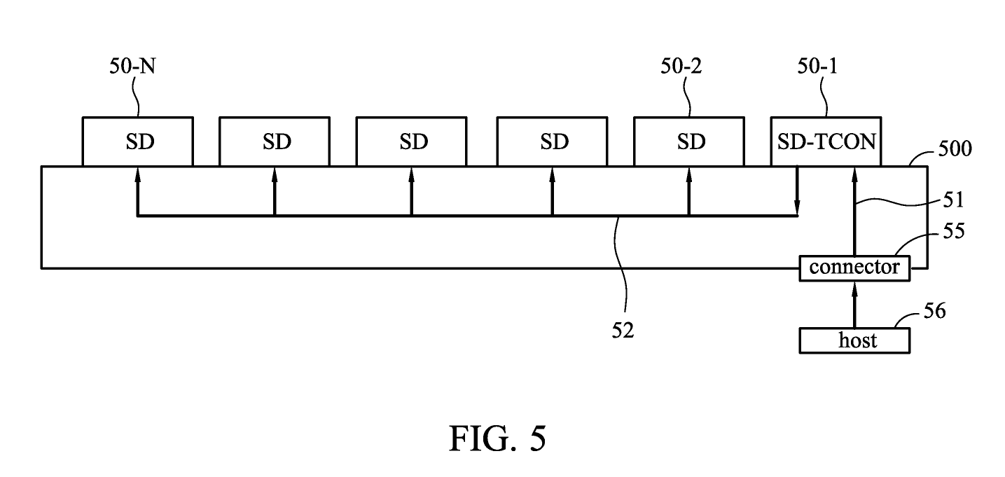

FIG. 5 shows a schematic layout of a driving circuit according to a third embodiment of the invention. It should be noted that for simplicity, only the components related to the proposed layout structure will be shown and discussed. For persons with ordinary skill in the art, it is easy to derive the non-discussed elements and circuits of FIG. 5, and the invention is not limited thereto. As shown in FIG. 5, the driving circuit comprises a printed circuit board 500, a plurality of source driver chips 50-1, 50-2, . . . , 50-N, a plurality of transmission lines 51 and 52 routed on the printed circuit board 500 and connected to the source driver chips, and a connector 55 located on the printed circuit board 500 and coupled to the host 56 and at least one source driver chip. According to the third embodiment of the invention, only one source driver chip 50-1 comprises a timing controller integrated therein and is represented by SD-TCON. The source driver chip 50-1 is coupled to the connector 55 via the transmission line 51. The source driver chips that are not coupled to the connector 55 are represented by SD. All of the source driver chips 50-1, 50-2, . . . , 50-N are coupled to each other via the transmission line 52.

According to an embodiment of the invention, the timing controller of the source driver chip 50-1 receives the image control signal provided by the host 56 from the connector 55, generates the timing control signals and the pixel signals according to the image control signal, and the source driver chip 50-1 transmits the timing control signals and the pixel signals to the source driver chips 50-2, . . . , 50-N that are not coupled to the connector. According to an embodiment of the invention, the timing control signals may comprise a start pulse signal (as an example, an EIO signal) for each source driver chip to indicate the time for the source driver chip to latch pixel data, a pixel clock signal to indicate a pixel data transmission frequency of the pixel signals, and a data enable signal indicating whether the pixel data of the pixel signals is active data or blanking data. The source driver chips 50-1, 50-2, . . . , 50-N then output corresponding pixel data to the data lines D1, D2, . . . , Dm as shown in FIG. 1 according to the timing control signals and the pixel signals.

In one aspect of the embodiment of the invention, a transmission speed of the transmission line 51 may be faster than that of the transmission line 52. As an example, the transmission line 51 may be an LVDS bus, and the transmission line 52 may be an RSDS bus. The transmission line 52 may also be any other transmission interface with fewer data lines as compared to the conventional transmission lines. According to the embodiment of the invention, the source driver chips 50-1, 50-2, . . . , 50-N may be packaged on the PCB 500 by the Chip On Film (COF) or the Chip On Glass (COG) package technologies. As can be seen, since the timing controller is integrated in the source driver, the PCB area required by the timing controller in the conventional design is decreased.

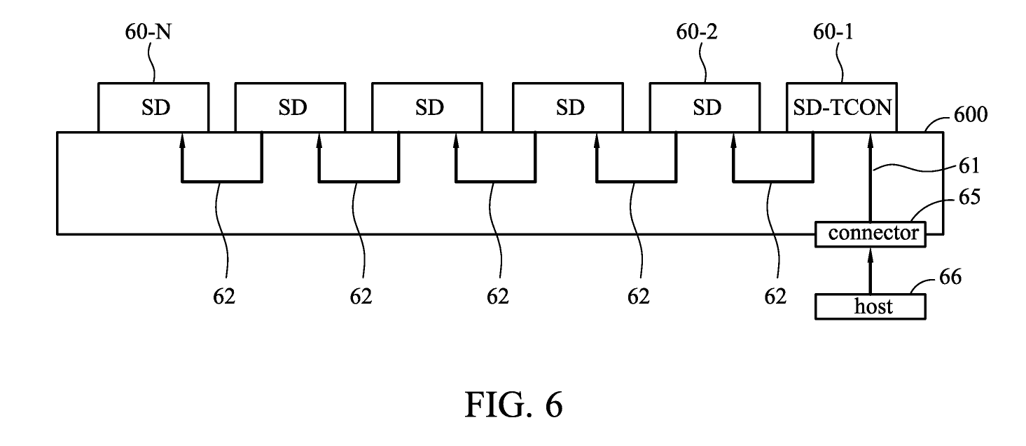

FIG. 6 shows a schematic layout of a driving circuit according to a fourth embodiment of the invention. It should be noted that for simplicity, only the components related to the proposed layout structure will be shown and discussed. For persons with ordinary skill in the art, it is easy to derive the non-discussed elements and circuits of FIG. 6, and the invention is not limited thereto. As shown in FIG. 6, the driving circuit comprises a printed circuit board 600, a plurality of source driver chips 60-1, 60-2, . . . , 60-N, a plurality of transmission lines 61 and 62 routed on the printed circuit board 600 and connected to the source driver chips, and a connector 65 located on the printed circuit board 600 and coupled to the host 66 and at least one source driver chip. According to the fourth embodiment of the invention, only one source driver chip 60-1 comprises the timing controller integrated therein and is represented by SD-TCON. The source driver chip 60-1 is coupled to the connector 65 via transmission line 61. The rest source driver chips that are not coupled to the connector 65 are represented by SD. Each pair of adjacent source driver chips (as an example, 60-1 and 60-2, 60-2 and 60-3, . . . , and 60-(N−1) and 60-N) are coupled to each other via the transmission line 62.

According to an embodiment of the invention, the timing controller of the source driver chip 60-1 receives the image control signal provided by the host 66 from the connector 65, generates the timing control signals and the pixel signals according to the image control signal, and the source driver chip 60-1 transmits the timing control signals and the pixel signals to an adjacent source driver chip, such as 60-2, that is not coupled to the connector. The source driver chip that is not coupled to the connector relays the received timing control signals and the pixel signals to its adjacent source driver chip one by one. According to an embodiment of the invention, the timing control signals may comprise a start pulse signal (as an example, an EIO signal) for each source driver chip to indicate the time for the source driver chip to latch pixel data, a pixel clock signal to indicate a pixel data transmission frequency of the pixel signals, and a data enable signal indicating whether the pixel data of the pixel signals is active data or blanking data. The source driver chips 60-1, 60-2, . . . , 60-N then output corresponding pixel data to the data lines D1, D2, . . . , Dm as shown in FIG. 1 according to the timing control signals and the pixel signals.

In one aspect of the embodiment of the invention, a transmission speed of the transmission line 61 may be faster than that of the transmission line 62. As an example, the transmission line 61 may be an LVDS bus, and the transmission line 62 may be an RSDS bus. The transmission line 62 may also be any other transmission interface with fewer data lines as compared to the conventional transmission lines. According to the embodiment of the invention, the source driver chips 60-1, 60-2, . . . , 60-N may be packaged on the PCB 600 by the Chip On Film (COF) or the Chip On Glass (COG) package technologies. As can be seen, since the timing controller is integrated in the source driver, the PCB area required by the timing controller in the conventional design may be saved. Thus the PCB area may be shrunk.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display device, comprising:
a panel comprising a plurality of light emitting elements and display cells, wherein the display cells are respectively connected to a plurality of data lines and gate lines;
a plurality of source driver chips outputting a plurality of pixel signals to the data lines, wherein at least one source driver chip comprises a timing controller integrated therein for generating a plurality of timing control signals and the pixel signals according to an image control signal provided by a host;
a gate driver chip outputting corresponding scan signals to the gate lines;
a printed circuit board; and
a plurality of transmission lines routed on the printed circuit board and connected the source driver chips.

2. The display device as claimed in claim 1, further comprising:
a connector located on the printed circuit board and coupled to the host and at least one source driver chip,
wherein each source driver chip comprises one timing controller integrated therein, and each source driver chip is coupled to the connector via the transmission lines.

3. The display device as claimed in claim 2, wherein the transmission lines are low voltage differential signaling (LVDS) buses.

4. The display device as claimed in claim 1, further comprising:
a connector located on the printed circuit board and coupled to the host and at least one source driver chip,
wherein each source driver chip comprises one timing controller integrated therein and only one source driver chip is coupled to the connector via a first transmission line, and the source driver chips are coupled to each other via a second transmission line.

5. The display device as claimed in claim 4, wherein a transmission speed of the first transmission line is faster than that of the second transmission line.

6. The display device as claimed in claim 4, wherein the first transmission line is a low voltage differential signaling (LVDS) bus, and the second transmission line is a reduced swing differential signaling (RSDS) bus.

7. The display device as claimed in claim 4, wherein the timing controller of the source driver chip coupled to the connector receives the image control signal from the connector, and generates the timing control signals and the pixel signals, accordingly, and the source driver chip coupled to the connector transmits the timing control signals and the pixel signals to the source driver chips that are not coupled to the connector.

8. The display device as claimed in claim 7, wherein the timing control signals comprise a pixel clock signal indicating a pixel data transmission frequency of the pixel signals and a data enable signal indicating whether the pixel data of the pixel signals is active data or blanking data.

9. The display device as claimed in claim 1, further comprising:
a connector located on the printed circuit board and coupled to the host and at least one source driver chip,
wherein only one source driver chip comprises the timing controller integrated therein and is coupled to the connector via a first transmission line, and the source driver chips are coupled to each other via a second transmission line.

10. The display device as claimed in claim 9, wherein the timing controller receives the image control signal from the connector, and generates the timing control timing controller transmits the timing control signals and the pixel signals to the source driver chips that are not coupled to the connector.

11. The display device as claimed in claim 9, wherein a transmission speed of the first transmission line is faster than that of the second transmission line.

12. The display device as claimed in claim 1, further comprising:
a connector located on the printed circuit board and coupled to the host and at least one source driver chip,
wherein only one source driver chip comprises the timing controller integrated therein and is coupled to the connector via a first transmission line, and each pair of adjacent source driver chips are coupled to each other via a second transmission line.

13. The display device as claimed in claim 12, wherein the timing controller receives the image control signal from the connector, and generates the timing control signals and the pixel signals, accordingly, and the source driver chip comprising the timing controller transmits the timing control signals and the pixel signals to an adjacent source driver chip that is not coupled to the connector, and the source driver chips that is not coupled to the connector relays the received timing control signals and the pixel signals to its adjacent source driver chip one by one.

14. The display device as claimed in claim 12, wherein a transmission speed of the first transmission line is faster than that of the second transmission line.

15. A driving circuit for outputting a plurality of pixel signals to control a liquid crystal display panel, and the liquid crystal display panel including a plurality of light emitting elements and display cells respectively connecting to a plurality of data lines and gate lines, comprising:
a plurality of source driver chips outputting the pixel signals to the data lines, wherein one source driver chip comprises a timing controller integrated therein for generating a plurality of timing control signals and the pixel signals according to an image control signal provided by a host;
a printed circuit board; and
a plurality of transmission lines routed on the printed circuit board and connected to the source driver chips.

16. The driving circuit as claimed in claim 15, further comprising:
a connector located on the printed circuit board and coupled to the host and the source driver chip comprising the timing controller,
wherein the source driver chip comprising the timing controller integrated therein is coupled to the connector via a first transmission line, and the source driver chips are coupled to each other via a second transmission line, and the transmission speed of the first transmission line is faster than that of the second transmission line.

17. The driving circuit as claimed in claim 16, wherein the timing controller receives the image control signal from the connector, and generates the timing control signals and the pixel signals, accordingly, and the source driver chip comprising the timing controller transmits the timing control signals and the pixel signals to the source driver chips that are not coupled to the connector.

18. The driving circuit as claimed in claim 16, wherein the first transmission line is a low voltage differential signaling (LVDS) bus, and the second transmission line is a reduced swing differential signaling (RSDS) bus.

19. The driving circuit as claimed in claim 15, further comprising:
a connector located on the printed circuit board and coupled to the host and the source driver chip comprising the timing controller,
wherein the source driver chip comprising the timing controller integrated therein is coupled to the connector via a first transmission line, and each pair of adjacent source driver chips are coupled to each other via a second transmission line.

20. The driving circuit as claimed in claim 19, wherein the timing controller receives the image control signal from the connector, and generates the timing control signals and the pixel signals, accordingly, and the source driver chip comprising the timing controller transmits the timing control signals and the pixel signals to an adjacent source driver chip that is not coupled to the connector, and the source driver chip that is not coupled to the connector relays the received timing control signals and the pixel signals to its adjacent source driver chip one by one.

21. The driving circuit as claimed in claim 19, wherein the first transmission line is a low voltage differential signaling (LVDS) bus, and the second transmission line is a reduced swing differential signaling (RSDS) bus.
